(19) United States
(12) Patent Application Publication
(10) Pub. No.: US 2021/0397607 A1
(43) Pub. Date: Dec. 23, 2021

(54) INSTANT SELECTABLE REMOTE DATA SYSTEM

(71) Applicant: Mosaic ATM, Inc., Leesburg, VA (US)

(72) Inventors: Frederick P. Wieland, Reston, VA (US); Amanda L. Tevis, Leesburg, VA (US); Michael B. Hill, Apollo Beach, FL (US); Christopher R. Brinton, Leesburg, VA (US)

(73) Assignee: Mosaic ATM, Inc., Leesburg, VA (US)

(21) Appl. No.: 17/349,751

(22) Filed: Jun. 16, 2021

Related U.S. Application Data
(60) Provisional application No. 63/041,641, filed on Jun. 19, 2020.

(51) Int. Cl. G06F 16/245; G06F 16/248; G06Q 30/00; G06F 21/62

(52) U.S. Cl. CPC G06F 16/245; G06F 16/248; G06Q 30/0631; G06F 21/6263; G06Q 30/01

(57) ABSTRACT

Systems and methods for accessing and/or viewing selectable remote data such as video data are provided. In one aspect, the system searches and matches a user with a database of registered data providers, the matched data provider providing the user-requested data in real-time under negotiated terms. The data may be filtered before delivery to conform to additional requirements, such as removal of personally identifiable information. The data may be multi-media data, e.g., image, video, audio, and may be provided by the geographically dispersed data provider via mobile or stationary devices on demand or on a scheduled basis in response to a request from a user/consumer.

### CROSS-REFERENCE TO RELATED APPLICATION

This application is a nonprovisional patent application of and claims the benefit of U.S. Provisional Patent Application No. 63/041,641 titled “Instant Selectable Remote Data System” and filed Jun. 19, 2020, the disclosure of which is hereby incorporated herein by reference in entirety.

### FIELD

The disclosure relates generally to systems and methods involving instant selectable remote data, and specifically to systems and methods for accessing and/or viewing selectable remote data such as video data.

### BACKGROUND

Remote access to instant or near real-time data describing a geographically distant site has been demanded for decades by a variety of users. For example, military users may seek such surveillance data for intelligence purposes, while commercial users may request such data to achieve logistical efficiencies through identification of shipping restrictions. Individuals may seek instant remote data for personal interests, such as imagery of post weather-event conditions at a distant vacation site prior to booking of airfare. Conventional approaches and methods for providing instant remote data are unavailable for public or individual use (e.g., military systems), cost-prohibitive (e.g., commercial satellite systems), and/or of extremely limited geographical coverage (e.g., a webcam at a national park). What is needed is a system and method that can provide on-demand or instant remote access or viewing of data on a global basis and that satisfies individual user requirements.

The disclosure solves these needs. More specifically, the disclosure provides systems and methods for accessing and/or viewing selectable remote data such as video data. With the relatively recent rise of ubiquitous video and camera equipped smartphones, and associated world-wide internet access, the potential exists to leverage a global network of potential data providers that may provide on-demand data to satisfy a user data request.

### SUMMARY

A system is disclosed that searches and matches a user with a database of registered data providers, the matched data provider providing the user-requested data in real-time under negotiated terms. The data may be filtered before delivery to conform to additional requirements, such as removal of personally identifiable information. The data may be multi-media data, e.g., image, video, audio, and may be provided by the geographically dispersed data provider via mobile (e.g., smartphone) or stationary devices (e.g., a tripod-mounted camera) on demand or on a scheduled basis in response to a request from a user/consumer.

In one embodiment, a remote data delivery system is disclosed, the system comprising: a set of remote data provider electronic devices each operated by a remote data provider, each of the set of remote data provider electronic devices configured to: a) transmit a remote data provider registration data set comprising a remote data provider profile and a remote data provider state, the remote data provider state comprising a remote data provider location, a remote data provider data collection format, and a remote data provider temporal availability, and b) collect and transmit a remote data provider nominal data set; a user electronic device operated by a user, the user electronic device configured to transmit a user data collection request comprising user data collection requirements, the user data collection requirements comprising user requested data collection location, user data collection time, and user requested data collection format; and a central processing hub configured to: a) receive the remote data provider registration data sets from each of the remote data provider electronic devices, b) enable the user to view the remote data provider registration data sets using the user electronic device, c) receive the user data collection request, d) enable each of the remote data providers to view the user data collection request using the respective remote data provider electronic device, e) sort the remote data provider data sets with respect to the user data collection request, and f) exchange data collection proposed terms between the user and each of the remote data providers; wherein: the central processing hub sorts the remote data provider data sets with respect to the user data collection request to identify a set of bona fide remote data providers, the set of bona fide remote data providers satisfying the user data collection requirements; the user selects a particular remote data collection provider from the set of bona fide remote data providers; the central processing hub exchanges data proposed terms between the user and the particular remote data provider; and if the data collection proposed terms yield data collection final terms, the remote data provider electronic device of the particular remote data provider collects a particular remote data provider nominal data set and transmits the particular remote data provider nominal data set to the user electronic device by way of the central processing hub.

In one aspect, the set of bona fide remote data providers and a particular recommended bona fide remote data provider are presented to the user on the user electronic device, the particular recommended bona fide remote data provider identified by the central processing hub. In another aspect, the geo-location of the set of bona fide remote data providers are presented in a map display to the user on the user electronic device. In another aspect, the user requested data collection format is at least one of video data, still photograph data, and audio data. In another aspect, the user communicates with the particular remote data provider in real-time regarding the user data collection requirements. In another aspect, the data collection proposed terms comprise pricing terms and payment terms. In another aspect, the central processing hub filters the particular remote data provider nominal data set to remove identifying data of the particular remote data provider.

In another embodiment, a remote data delivery system is disclosed, the system comprising: a first remote data provider electronic device operated by a first remote data provider, the first remote data provider electronic device operating to: a) transmit a first remote data provider registration data set comprising a first remote data provider profile and a first remote data provider state, the first remote data provider state comprising a first remote data provider location, first remote data provider temporal availability, and first remote data provider data collection format, and b) collect and transmit a first remote data provider nominal data set; a user electronic device operated by a user, the user electronic device operating to transmit a user data collection request comprising user data collection requirements, the user data collection requirements comprising user requested data collection location, user requested data collection time, and user requested data collection format; and a central processing hub operating to: a) receive the first remote data provider registration data set, b) enable the user to view the first remote data provider registration data set using the user electronic device, c) receive the user data collection request, d) enable the first remote data provider to view the user data collection request using the first remote data provider electronic device, and e) exchange data collection proposed terms between the user and the first remote data provider; wherein: if: a) the first remote data provider location matches the user requested data collection location, b) the first remote data provider collection temporal availability matches the user required data collection time, and c) the first remote data provider data collection format matches the user requested data collection format, the central processing hub exchanges data collection proposed terms between the user and the first remote data provider; and if the data collection proposed terms yield data collection final terms, the first remote data provider electronic device collects the first remote data provider nominal data set and transmits the first remote data provider nominal data set to the user electronic device by way of the central processing hub.

In one aspect, the data collection proposed terms comprise user proposed financial terms and first remote data provider proposed financial terms. In another aspect, the first remote data provider electronic device is a portable electronic device and the user electronic device is a portable electronic device. In another aspect, any identification data of the first remote data provider nominal data set is removed to create the first remote data provider value-added data set. In another aspect, the central processing hub is a cloud-computing system. In another aspect, the user requested data collection format is at least one of video data, still photograph data, and audio data. In another aspect, the user communicates with the first remote data provider in real-time regarding the user data collection requirements.

In yet another embodiment, a method of delivering selectable remote data to a user is disclosed, the method comprising: registering a set of remote data providers on a central processing hub, each remote data provider operating a remote data provider electronic device, each remote data provider electronic device configured to: a) transmit a remote data provider registration data set comprising a remote data provider profile and a remote data provider state, the remote data provider state comprising a remote data provider location, a remote data provider data collection format, and a remote data provider temporal availability, and b) collect and transmit a remote data provider nominal data set; transmitting a user data collection request from a user electronic device to the central processing hub, the user data collection request comprising user data collection requirements comprising user requested data collection location, user required data collection time, and user requested data collection format, the user electronic device operated by a user; selectively viewing, by the user on the user electronic device, one or more remote data provider registration data sets of the set of remote data providers; sorting, by the central processing hub, the set of remote data providers to identify a set of bona fide remote data providers which satisfy the user data collection requirements; selecting a particular remote data provider among the set of bona fide remote data providers; exchanging data collection proposed terms between the user and the particular remote data provider; establishing data collection final terms; collecting, by the remote data provider electronic device of the particular remote data provider, a particular remote data provider nominal data set; transmitting the particular remote data provider nominal data set the central processing hub; filtering the particular remote data provider nominal data set according to selectable criteria to create a filtered data set; and transmitting the filtered data set to the user electronic device.

In one aspect, the set of bona fide remote data providers is presented to the user on the user electronic device. In another aspect, the particular remote data provider nominal data set includes at least one of video data, still photograph data, and audio data. In another aspect, the selectable criteria removes identification data associated with at least one of: the particular remote data provider, people other than the particular remote data provider, and entities requiring deidentification. In another aspect, the user communicates with the particular remote data provider in real-time regarding the user data collection requirements. In another aspect, the data collection proposed terms comprise pricing terms and payment terms.

The phrase “augmented reality” and the term “A/R” mean to superimpose computer-generated data, such as an image, sound, or other feature onto a user's view of the real world, thereby providing a composite, supplemented, or augmented view. For example, a web-based computer system may superimpose a three-dimensional model of a measuring tool within a field of view of a camera system.

The word “app” or “application” means a software program that runs as or is hosted by a computer, typically on a portable computer, and includes a software program that accesses web-based tools, APIs and/or data.

The phrase “client-server” or “client-server architecture” means a shared computer architecture in which the server hosts, delivers and manages the majority of the resources (e.g., computing resources) and services to be consumed by a client. There may be multiple clients connected to a single server over a network or internet connection.

The phrase “cloud computing” or the word “cloud” refers to computing services performed by shared pools of computer resources, often over the Internet.

The term “geolocation” means the geographic location of an entity, typically provided as a set of latitude, longitude, and mean sea level coordinates.

The term “state” means a group of variables or characteristics that defines the condition of an entity, such as pressure and temperature may define the condition or state of a substance as a gas or a liquid.

The phrase “user interface” or “UI”, and the phrase “graphical user interface” or “GUI”, means a computer-based display that allows interaction with a user with aid of images or graphics.

The phrase “virtual reality” and the term “V/R” mean a computer-generated simulation or representation of a three-dimensional image or environment that may be interacted with in a seemingly real or physical way by a user using specialized electronic equipment, such as a helmet with a screen inside or gloves fitted with sensors.

By way of providing additional background, context, and to further satisfy the written description requirements of 35 U.S.C. § 112, the following references are incorporated by reference in their entireties: U.S. Pat. No. 8,250,616 to Davis issued Aug. 21, 2012; U.S. Pat. No. 10,171,254 to Davis issued Jan. 1, 2019; and U.S. Pat. No. 8,539,542 to Elhag issued Sep. 17, 2013.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably. The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

Various embodiments or portions of methods of manufacture may also or alternatively be implemented partially in software and/or firmware, e.g., analysis of signs. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The disclosure will be readily understood by the following detailed description in conjunction with the accompanying drawings, wherein like reference numerals designate like elements. The elements of the drawings are not necessarily to scale relative to each other. Identical reference numerals have been used, where possible, to designate identical features that are common to the figures.

FIG. 1 is a flow diagram of one method of using an instant selectable remote data system of the disclosure, such as the instant selectable remote data system described in FIGS. 2A-C; and

FIG. 2A is a schematic diagram of one embodiment of an instant selectable remote data system of the disclosure, the set of diagrams emphasizing a set of steps of the method of FIG. 1;

FIG. 2B is a schematic diagram of one embodiment of an instant selectable remote data system of the disclosure, the set of diagrams emphasizing a set of steps of the method of FIG. 1 and generally occurring after the set of steps of FIG. 2A; and

FIG. 2C is a schematic diagram of one embodiment of an instant selectable remote data system of the disclosure, the set of diagrams emphasizing a set of steps of the method of FIG. 1 and generally occurring after the set of steps of FIG. 2C.

### DETAILED DESCRIPTION

Reference will now be made in detail to representative embodiments. The following descriptions are not intended to limit the embodiments to one preferred embodiment. To the contrary, it is intended to cover alternatives, modifications, and equivalents as can be included within the spirit and scope of the described embodiments as defined, for example, by the appended claims.

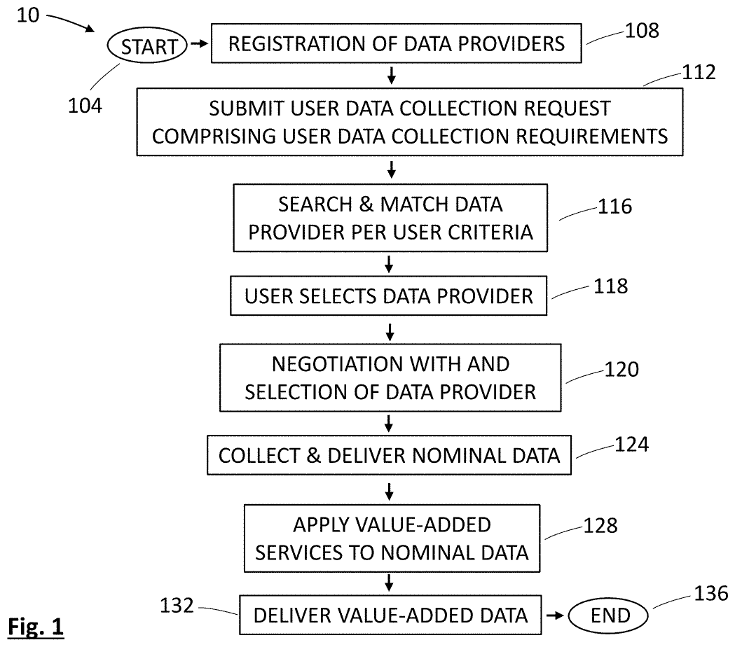

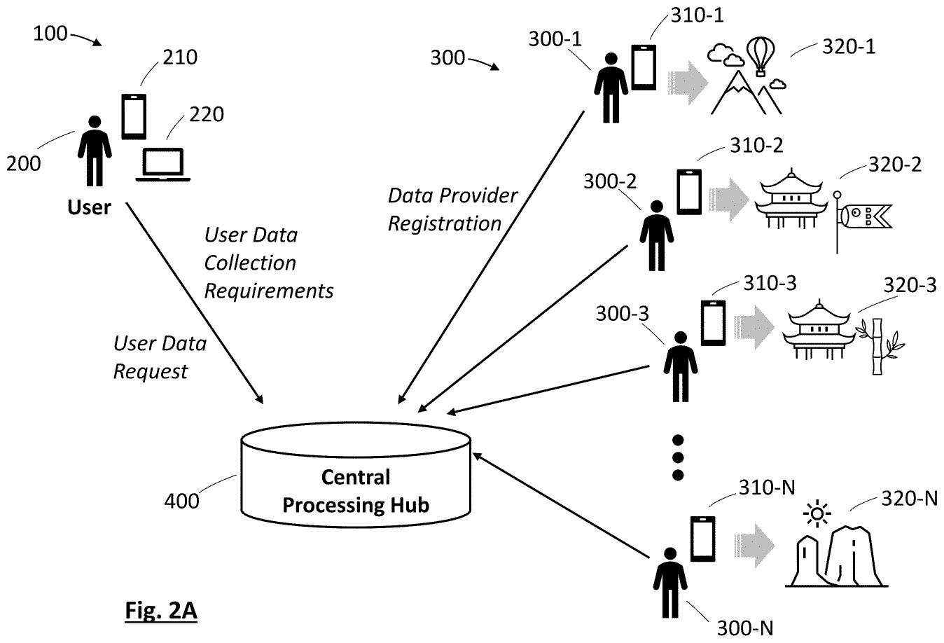

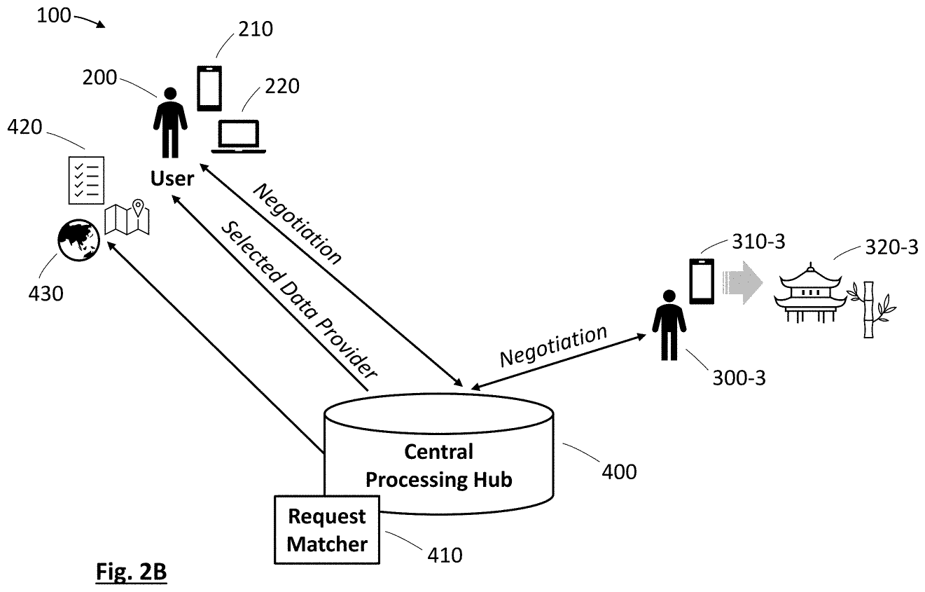

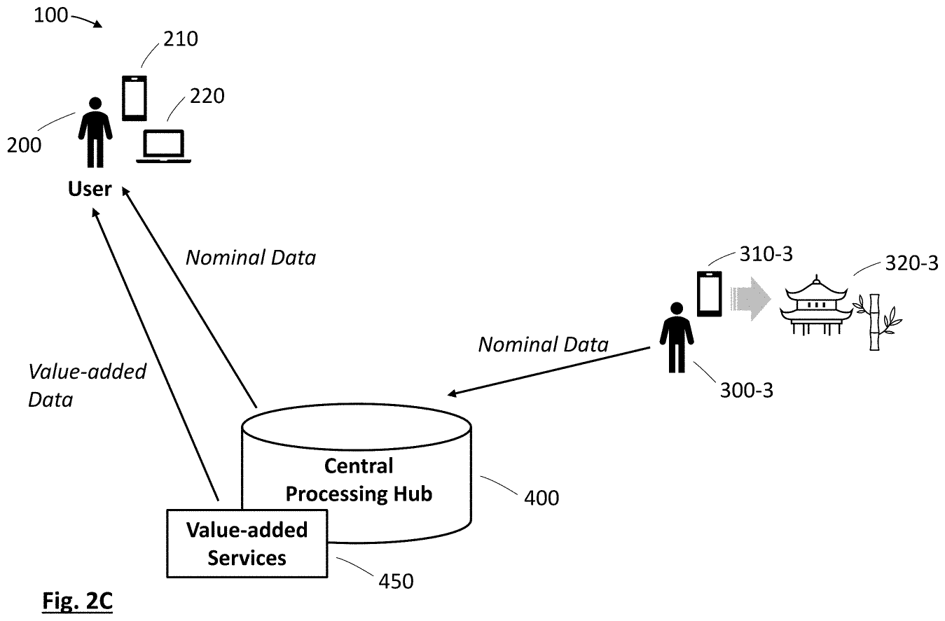

The disclosed devices, systems, and methods of use will be described with reference to FIGS. 1-2. Generally, systems and methods for accessing and/or viewing selectable remote data such as video data are disclosed. The instant selectable remote data system may be referred to as “remote data delivery system” or simply as the “system.” The method of use of the instant selectable remote data system may be referred to as the “method of delivering selectable remote data” or simply as the “method.”

Participating suppliers (aka “remote data providers” or “data providers”) of multi-media data communicate their location and availability to provide multi-media data from a mobile or stationary device, including supplier-specific fee structure via established fee parameters. The system matches consumer (aka “user”) requests for remote communication of electronic multi-media with an available supplier that satisfies the user request within the appropriate geographic region. The system provides the network connection between the supplier and the consumer, and processes payment from the consumer to the supplier. In some implementations, the supplier and consumer are not identified to each other, whereas the supplier and consumer may be identified to each other by mutual consent in other implementations. In some implementations, the multi-media stream is modified before being provided over the network (e.g., streamed) to the consumer to obscure identifying features such as faces and license plates.

The flow diagram of FIG. 1 presents one method 10 of using an instant selectable remote data system of the disclosure, such as the instant selectable remote data system 100 described in FIGS. 2A-C. FIGS. 2A-C are a set of schematic diagrams depicting collections of steps of the method of FIG. 1. After a description of each of FIGS. 1 and 2A-C, a series of example use cases is provided.

Generally, the method 10 of FIG. 1 starts at step 104 and ends at step 136. Any of the steps, functions, and operations discussed herein can be performed continuously and automatically. In some embodiments, one or more of the steps of the method of use 10, to include steps of the method 10, may comprise computer control, use of computer processors, and/or some level of automation. The steps are notionally followed in increasing numerical sequence, although, in some embodiments, some steps may be omitted, some steps added, and the steps may follow other than increasing numerical order. When the method references a user, the user 200 may be a single user or a set of users that coordinate requirements that are provided to the system 100. A user 200 may interact or perform one or more of the described steps by using one or more user electronic device(s) comprising a display/GUI, to include a smartphone or other portable electronic device 210, and/or a desktop electronic device 220. The one or more user electronic device(s) may comprise an app to enable user 200 interaction with the system 100, to include real-time or near real-time interaction with one or more data providers 300.

Generally, the instant selectable remote data system 100 of FIGS. 2A-C comprises a central processing hub 400, a user 200, and a set of remote data providers 300. The instant selectable remote data system 100 allows a user 200 to initiate a request for multi-media data of defined character (e.g., at a defined location, at a defined time, of defined objects, of defined data format, etc.) to be provided as an individual transaction between a remote data provider and the user. In contrast, at best conventional systems assume or require potential data providers to already be streaming data and/or streaming data of a character not selectable by a user.

The user 200 interacts or engages with the system 100 by way of one or both of an electronic device 210 such as a smartphone, and/or a desktop electronic device 220 such as a laptop. The electronic device 210 may be a portable electronic device. The user 200 provides or submits a user data collection request, the user data collection request comprising a set of user data collection requirements (see step 112 of FIG. 1). The set of user data collection requirements may include, e.g., the data collection location or the geolocation of the data request (e.g. a specific botanical park in Tokyo, Japan), the user requested data collection format or type of data requested (e.g. video), the user data collection time or time the data is to be recorded (e.g. within the next 1 hour, immediately, or at 11 am local time), and any specific items to be recorded (e.g. a type of bamboo tree within the botanical park). Other user data requirements are possible, such as price ranges or price caps, lighting conditions, camera settings e.g., “F-Stop” setting, and the like. In one embodiment, the user may interact, in real-time or near real-time, with a particular data provider so as to provide additional or clarifying instructions or requirements based on real-time or near real-time viewing of data provided by the data provided. Such interaction may be by any of several means, to include by video, audio, text, etc. For example, the user may select a particular flower within a set of flowers of a blooming plant at a botanical park that the data provider is to focus. Stated another way, the user may communicate (e.g., by audio, by video) with a particular data provider and provide further user data collection requirements. In one embodiment, the user may engage the user electronic device to guide the orientation of a particular data provider's electronic device that collects the user requested data. For example, the user may engage embedded app controls to orient or control a video camera of the particular data provider. In one embodiment, the user electronic device, through an app or otherwise, allows the user 200 to personalize user GUI/display and/or features, such as account set-up and management, presentation of bono fide data providers (described below), data providers by selectable criteria (e.g., data provider geolocation), etc.

The user may also engage or access specific displays, such as map(s) 430 of remote data providers or list(s) 420 of remote data providers. In one embodiment, the map 430 presents the geolocation of all data providers within a user selectable or user identified geolocation, either in the present time or at a projected time/date. In one embodiment, the map 430 presents the geolocation of all data providers subject to search or sorting criteria provided by the user and culled or identified by the central processing hub (as described below).

User data collection requests comprising user data collection requirements are provided to central processing hub 400. The phrases “user requirements,” “user data requirements,” “user requirements data set,” and “data criteria” mean a set of values and/or terms established by a user that define a set of data of interest to a user. The word “data” and the phrase “multimedia data” mean a set of values of qualitative or quantitative variables about one or more persons or objects, and includes, without limitation, dynamic imagery, static imagery, and audio recordings, such data obtained by any of several means, to include, without limitation, a still camera, a video camera, a microphone, and a smartphone. The user data collection requirements, as briefly described above, may include user requested data collection geolocation (to include ranges of geolocation or a defined location, e.g., city boundaries of San Francisco, Calif., boundaries of Yosemite National Park, Calif., or boundaries of Tokyo Disneyland), user data collection time (e.g., immediate, next 2 hours, tomorrow between 2-4 pm Zulu time), and user data collection format (e.g., high-definition video, still camera, audio, etc.)

The central processing hub 400 (aka the “hub”) generally performs substantially all or the entirety of processing of the system 100. In addition to receipt, processing and storage of the user data requirements as discussed above, the hub 400 communicates with the set of data providers 300, performs user request matching, sorting, and/or filtering with respect to user requirements (by way of the Request Matcher 410 module of the hub 400), and performs value-added services to the data received from a particular remote data provider 300 (by way of the Value-added Services 450 module of the hub 400). The central processing hub 400 may sort the set of remote data providers to identify those data providers that conform to the set of user data collection requirements, deeming those sorted or filtered data providers as “bona fide remote data providers” or “bona fide data providers.” Such bona fide data providers may be presented on a map display of the user electronic device, and may vary with time (if, e.g., a data provider is available only during a set amount of time). The central processing hub 400 may also cull or sort or filter the set of data providers according to selectable user criteria, such as financial terms, time availability, data collection format, user quality ratings, etc. In some embodiments, the central processing hub (by way of the Request Matcher or otherwise) may identify a particular recommended bona fide remote data provider selected from the set of bona fide remote data providers, the particular recommended bona fide remote data provider presented to the user on the user electronic display. In some embodiments, the central processing hub may identify one or more particular recommended bona fide remote data providers selected from the set of bona fide remote data providers, the set of one or more particular recommended bona fide remote data providers presented to the user on the user electronic display.

In one embodiment, the central processing hub 400 may manage or sort or cull or filter the set of remote data providers into a public mode versus an enterprise mode wherein a subset of data providers is made available to the user. A remote data provider in public mode will be viewable or accessible to any user and thus will display on a user electronic device of any user. In contrast, a remote data provider in enterprise mode will only be viewable or accessible by designated users and/or on designated user electronic devices. Such a feature would be useful, e.g., if a particular remote data provider is asked to film structural damage to a vessel undergoing repair after an accident, the specifics of the damage confidential to the (business) user. The ability and availability of the particular data provider would only be known to the (business) user. (See Use Case 2 below).

The central processing hub 400 may also provide set-up/management of the user electronic device and user activities (e.g., provide financial accounting of user data collection purchases, manage receipt and validation of user payment to data providers), and/or set-up/management of remote data provider electronic devices and data provider activities (e.g., provide financial accounting of data provider data collection services, manage transfer of user payment to data providers).

In one embodiment, the hub 400 is one or more physical servers located at a designated physical location. In one embodiment, the hub 400 is a cloud-based processing system. In one embodiment, the hub 400 is a combination of physical server(s) and cloud-based system(s). In one embodiment, a portion of the processing of the central processing hub 400 is performed by the user electronic device and/or one or more of the remote data provider electronic device(s).

Each of the set of remote data providers 300 is capable of recording and/or transmitting data as generated at their particular physical location (or geolocation) by way of a remote data provider electronic device(s), such as a smartphone. The one or more remote data provider electronic device(s) may comprise an app to enable data provider 300 interaction with the system 100, to include real-time or near real-time interaction with the user 200. In one embodiment, the remote data provider electronic device, through an app or otherwise, allows the data provider 300 to personalize user GUI/display and/or features, such as account set-up and management and presentation of user data collection requests, etc.

In one embodiment, the remote data provider electronic device may allow the data provider to announce or broadcast that they are available for data collection at their current geolocation and/or will be available at specified times at another geolocation, thus allowing the remote data provider to go about their business while being available for data collection should a user so query or request. In one embodiment, the remote data provider receives a selectable passive notice (e.g., a pop-up display on their remote data provider electronic device) of a user data request and/or a selectable active notice (e.g., an audio alarm) of a user request.

Each of the remote data providers operate a remote data provider electronic device configured or operating to maintain and transmit a remote data provider registration data set and to collect and transmit a remote data provider nominal data set. The remote data provider registration data set comprises a remote data provider profile and a remote data provider state. The remote data provider profile may include one or more of data collection financial terms (e.g., price, payment means such as credit card, etc.), IP terms (e.g., copyright ownership), quality ratings and/or reviews, and the like. The remote data provider state may include one or more of data provider geolocation, data collection format (e.g., video, still camera or still photography, audio) and data provider temporal availability (e.g., now for next one hour, between certain times in Zulu or local time). The remote data provider state may be coupled to variables, e.g., the geolocation may be linked to the temporal availability of the data provider.

FIG. 2A presents a set of N remote data providers, each in a different geolocation and/or positioned for a different scene at a similar or same geolocation. For example, remote data provider 300-1 is positioned at a first geolocation and is engaged with an electronic device 310-1 which is positioned to record the scene 320-1. Similarly, remote data provider N is positioned at an N location with an electronic device 310-N which is positioned to record scene 320-N. (While each of remote data providers 300 are depicted with portable electronic device e.g., smartphones, any or all of the remote data providers 300 may be engaged with a different and/or additional data collection device, such as a spherical camera, statically-mounted video camera, sound-measuring sensor, etc.). In contrast, remote data providers 300-2 and 300-3 are located at the same geolocation yet are positioned for different scenes. Specifically, remote data provider 300-2 is positioned at a second location with an electronic device 310-2 which is positioned to record scene 320-2, while remote data provider 300-3 is positioned at the same or similar geolocation as remote data provider 300-2 yet positioned to record scene 320-3.

Each remote data provider 300 provides remote data provider registration data to the central processing hub 400. The remote data provider registration data has a remote data provider character, the remote data provider character comprising a set or array of data. Thus, the remote data provider registration data may be referred to as a remote data provider registration data set. The set or array of data of the remote data provider of each remote data provider comprises, for example, a remote data provider profile and a remote data provider state. The remote data provider profile may include range of available locations for data collection, time of availability of the data provider, data collection format or capabilities (e.g. only a smart phone camera of an identified type, optional high-speed video camera, etc.), cost schedule (e.g. $x per ten minute video, $y per still photo), payment type (e.g. only by credit card, only by PayPal), terms of data recording (e.g. exclusive copyright to user, no commercial use limitation), public or private (enterprise) access to the provider, special capabilities of the provider (e.g., that the provider provides guided remote tours of a particular site such as a museum or nature park), and general terms and conditions of the particular remote data provider. The remote data provider registration data provided to hub 400 by each of the remote data providers 300 may be time-limited or otherwise constrained, meaning for example a particular data provider may have seasonal rates, rates that vary with time of day, etc. The remote data provider state may include readiness level of the data provider (e.g., on-line and ready to generate data), instant or specific location of the data provider (e.g., at main entrance to a specified theme park), and current capabilities of the data provider (e.g., video capabilities are inoperative, but still camera capabilities are available).

Returning to the method 10 of FIG. 1, after starting the method 10 at step 104, the method 10 proceeds to step 108. At step 108, each of the set of remote data providers are registered with the central processing hub 400. Stated another way, the central processing hub 400 receives and stores a remote data provider registration data set as transmitted by a respective remote data provider electronic device of each remote data provider. The collection of remote data provider registration data sets is stored and managed by the central processing hub in a manner that allows sorting, filtering, searching, and standard data management tasks to be performed, as known to those skilled in the art.

FIG. 2A illustrates step 108. Each of N remote data providers are depicted (300-1, 300-2, 300-3, through to 300-N) are depicted in different locations and/or data capture orientations and providing registration data to central processing hub 400. After completing step 108, the method 10 continues to step 112.

At step 112, a user submits a user data collection request, the user data collection request comprising a set of user data collection requirements. The user 200 submits the data request by way of a user electronic device, as described above. The data request comprises user data collection requirements, as described above. In one embodiment, the user may submit a use data collection request by way of a web interface, e.g., through a website or web portal. The user may use any number of tools to assist or aid in entering the user data request. For example, the user may first review a map view of available data providers in the location and/or time of interest, avoiding the delay associated with submitting a request for data at a location or during a time in which no data provider is available. Such maps are presented on the user electronic device and generated or rendered with aid of or by the central processing hub 400. As described above, in some embodiments the user may be restricted to only view a subset of the registered data providers, such as only those data providers that are public to any user. The user may also perform other initial filtering of the data providers, e.g., filter to list or otherwise view only those data providers who are capable of engaging the user in real-time to receive real-time instructions on data capture as described above.

FIG. 2A also illustrates step 112 in that the user 200 is sending a user data request, comprising user data criteria, to the central processing hub 400. The user 200 may use one or both of the depicted smartphone or other portable electronic device 210 and desktop electronic device 220 to sending the data request (or view aspects of the available data providers as described). After completing step 112, the method 10 proceeds to step 116.

At step 116, the central processing hub performs a sorting or culling of the set of remote data providers to identify those data providers that satisfy the set of user data collection requirements. Stated another way, the collection of user requirements for data collection are searched against the registration data set for the collection of remote data providers. The set of remote data providers that so satisfy the set of user data collection requirements is deemed a set of bona fide remote data providers.

By way of illustration and with attention to FIGS. 2A, if the user 200 requests video of a particular type of bamboo tree located at a particular Japanese park in Tokyo, the hub 400 searches through the registration data of the set of remote data providers (to include e.g. data provider profile data and data provider state data) to initially determine that two data providers (300-2 and 300-3) are located at the user required geolocation yet only one (300-3) is positioned to record or generate the specific data required (of the particular type of bamboo tree). The searching process of step 116 then selects or matches or sorts the set of data providers to identify a particular data provider (in the example, data provider 300-3) as the only bona fide data provider, meaning the only data provider that satisfies the entire set of user data collection requirements. As depicted in FIG. 2B, the sorted or recommended data provider (300-3) is presented or highlighted to the user. Note that in some scenarios, more than one bona fide data provider may be presented or recommended to user 200.

Note that the hub 400, by way of Request Matcher 410, may generate a list 420 of potential data providers and/or a map 430 of potential data providers to assist the user 200 in investigating or assessing the candidate set of data providers that may satisfy all or some of the user data collection requirements. (Such a list 420 and map 430 may be made available to the user 200 by way of electronic devices 210 and/or 220). For example, the Request Matcher 410 may generate a map that depicts data providers as a first (e.g. green) icon which satisfy all user data requirements (in the example above involving a particular type of bamboo tree at a Japanese park, data provider 300-3 satisfies all requirements) yet also show any data providers as a second (e.g. yellow) icon that satisfy some of the user data requirements (in the same example, data provider 300-2, which satisfies the geolocation requirement but not the bamboo tree requirement).

The Request Matcher may automatically select a single provider to recommend to the user from a candidate list of multiple qualifying providers. The Request Matcher may, for example, select the single provider based on the price to be charged by each qualifying provider, previous user review/ratings of the qualifying providers, and/or recent frequency of selection of each of the qualifying providers to attempt to equitably distribute the selection of each provider. Preference may be given in the Request Matcher to providers with higher review ratings or based on other criteria. A user may selectively establish preference criteria to govern the Request Matcher selection of a single provider. Such user preference criteria may include relative weightings of Request Matcher preferences, such as, for example, 75% weighing based on review ratings and 25% based on price.

At the completion of step 116, the method 10 proceeds to step 118. At step 118, the user selects a particular data provider to which to negotiate with for execution of the user data collection request. (In some embodiments, the user may select the recommended single remote data provider, as recommended by the Request Matcher. In some embodiments, the recommended single data provider, as recommended by the Request Matcher, is automatically selected without user input, and step 118 is absent). From the list, map, or other depiction of data providers of interest and/or bona fide data providers, the user 200 selects a particular data provider to enter negotiations. After completion of step 118, the method 10 proceeds to step 120.

At step 120, a negotiation between the user 200 and the system-recommended or user-selected particular remote data provider is enabled by the central processing hub 200. The negotiation step is depicted in FIG. 2B between the user 200 and the particular data provider 300-3. The negotiation may involve, for example, the specific terms and conditions of the data collection by the particular data provider, such as price, recording specifics, etc. The negotiation may occur in any of several ways, to include specific data exchange between the user 200 and the particular recommended data provider (e.g., back and forth on price), semi-automatically e.g., the user 200 simply affirms the system's 100 recommended data provider, to fully or substantially automatic in which the system 100 performs negotiation based on user-provided user requirements data. For example, the user may have provided a price range for defined video recording lengths and the system 100 works within that range to obtain an agreed-to price. A result of the negotiation step 120 is that final terms of data delivery (of the user defined data) is determined. Stated another way, a successful negotiation between the user 200 and the user-selected data provider yields data collection final terms. After completion of step 120, the method 10 proceeds to step 124.

At step 124, the nominal set of data, as negotiated with the particular data provider (aka the user-selected data provider), is collected and delivered to the user 200 by way of the hub 400. As described above, in some embodiments, the user 200 provides supplemental guidance or instruction to the user-selected particular data provider regarding the data collection, such as providing specific guidance on data collection angles, subject, lighting, etc. by any of several means, such as by audio, facetime, texting, etc. Some minimal processing of the nominal data gathered may be performed by the hub 400, e.g., removal of start-up errant pointing of a video at the data provider's knee or towards the sky, prior to transmittal of the data to the user 200. The delivery of the nominal data from the central processing hub 400 to the user 200 is depicted in FIG. 2C. After completion of step 124, the method 10 proceeds to step 128.

At step 128, value-added services may be applied to the nominal data. For example, the Value-added Services module 450 of the central processing hub 400 may filter the nominal data to user-selectable criteria. For example, the selectable criteria may require the removal of identification data associated with, for example, the particular remote data provider, people other than the particular remote data provider, and/or entities requiring deidentification. The value-added services may remove metadata that may identify the personal data of the particular data provider. Such processing serves to shield the identities of the provider and/or user (consumer) and keep their identities secure (although either or both parties may optionally identify themselves during the above-described supplemental guidance, if they so choose).

After performing the value-added services at step 128, the method 10 proceeds to step 132 wherein the central processing hub 400 delivers the value-added data to the user 200. The delivery of the value-added data from the central processing hub 400 to the user 200 is depicted in FIG. 2C. After completing step 132, the method ends at step 136.

In one embodiment, all or some of the processing of the hub 400 is performed by one or more electronic devices of the user 200, such as the devices 210, 220 described.

In one embodiment, the system 100 is configured in a client-server architecture. In one embodiment, the content (either or both of nominal content and value-added content) is provided to the user with A/R features. In one embodiment, the content (either or both of nominal content and value-added content) is provided to the user in a V/R configuration. In one embodiment, one or more display/GUIs accessed by the user 200 provides real-time, updated information about geographic areas of the world from which live electronic multi-media can be provided from registered suppliers. In one embodiment, the system 100 provides automatic matching and selection of a multi-media data supplier based on criteria specific by the consumer, such as price offered, timeliness (i.e., wait time tolerance), duration, perspective (i.e., required angle and altitude of viewing), etc. In one embodiment, the system 100 provides electronic negotiation and coordination of payment by consumer to provider. In one embodiment, the system 100 provides real-time analysis and modification of the captured data to obscure identifying features resulting in filtered multi-media data. In one embodiment, the system 100 provides communication of the filtered multi-media data over a network and formatted for rendering in the consumer's browser or mobile phone application.

In some embodiments, the central processing hub 400 may provide additional services, as selected by a user. For example, the central processing hub 400 may provide: object identification wherein objects of interest are identified or tagged in a photograph; moving object tracking wherein, in a video, a moving object may be tracked and identified (e.g., a car, truck, bicyclist, etc.), and selectable objects may be framed, e.g. a frame may be inserted around a moving vehicle wherein the frame moves as vehicle moves. The central processing hub 400 may also enable, perform, or facilitate Machine Learning/pattern recognition applications. For example, if outdoors, the hub may determine the weather (sunny/cloudy/rainy/snowy), determine disposition of people (happy/sad/concerned/etc.), and/or rate general condition of area (well maintained, average, dilapidated).

A series of example and non-limiting use cases of the instant selectable remote data system will now be provided. In each of the following examples, the numbered steps 1-7 generally correspond to the steps 108, 112, 116, 120, 124, 128, and 132, respectively, of the method 10 of FIG. 1 and described above. Note that the phrase “video providers” below means more broadly “data providers” as described above and may include parties that provide video data.

### Example Use Case 1

A user seeks photos of a vacation home after a storm.

1. Registration of Remote Data Providers (All Are Video Data Providers)

Individual mobile device owners who have installed an application on their mobile device that implements the mobile device component of the instant selectable remote data system and use the mobile device application to indicate whether or not they are available to receive multimedia data requests. When they are available, the mobile device application continuously sends the geographical location of the device to the central processing hub. The central processing hub keeps a running list of available multi-media data providers, along with their locations, as well as pricing, capabilities, and constraints for each provider.

2. Submission of Multimedia Data Request by Consumer User.

An individual user who desires a photo or video of a specific geographic location/entity uses a website that implements the instant selectable remote data system to enter the location of the desired photo or video, and other parameters and instructions, such as viewing angle of the photo or video, price that the consumer is willing to pay, time by which the photo or video is required, etc.

3. Search and Matching of Data Provider Per User Criteria

The Request Matcher at the central processing hub searches the current list of available multi-media data providers and identifies a single provider that is currently available, meets the identified constraints in the consumer's criteria, and has the minimum total cost required to provide the multimedia data. The selected provider is notified by the central processing hub that the provider has a pending request. After the provider acknowledges and accepts the request, the consumer is notified that a provider is available, along with any additional information, such as estimated time to availability of the multimedia data.

4. Negotiation Between User and Matched Data Provider Per User Criteria

The system allows the consumer and selected provider to communicate with each other, without sharing any personally identifiable information. The invention may block names, phone numbers, email addresses, or other personally identifiable information during this communication. Additional negotiation may occur, including additional fees and amount of time available to complete the transaction. For example, the provider may need to travel to the location of the consumer's request, which may include tolls to be paid, or other travel-related charges, as well as time. Both parties must agree through the application to the additional fees and requirements.

5. Delivery of Nominal Data by the Selected Data Provider to the Central Processing Hub

After the negotiations have been completed and all conditions accepted by both parties, the provider positions itself according to the agreed requirements and collects the requested multimedia data. The multimedia data is streamed or otherwise transmitted by network from the provider to the central processing hub.

6. Value-Added Services (e.g., Filtering) Applied to the Nominal Data

The central processing hub receives the multimedia data and the Multimedia Data Processor (aka Value-added Services module 450) performs value-added services, such as filtering, to the multimedia data. For example, the Multi-Media Data Processor may perform real-time analysis of video or images to detect human faces or license plates. If detected, these items will be obscured in the image so that they cannot be used as personally identifiable information.

Another example of a value-added service is for the central processing hub to allow individuals (not consumers or providers, in general) to verify ownership of their property and then indicate to the system implementing the invention that their property is not to be included in any multimedia data provided by the system. If this value-added service is enabled in the system, then multimedia data is analyzed by the Multimedia Data Processor to identify and obscure or block any segments of the image or video that are identified by the system to be from any blocked properties.

7. Delivery of Value-Added Data to the User

After the Multimedia Data Processor performs appropriate filtering on the nominal multimedia data to generate the value-added multimedia data, the multimedia data is then streamed or transmitted via a computer network to the consumer.

Use Case 2

An airport ramp manager wants to monitor live airport ramp operations. This use case addresses an enterprise deployment, in which the providers of video/images are employees or agents of an enterprise that can direct their actions.

1. Registration of Video Providers

Individual mobile devices are assigned to selected employees of the enterprise. The mobile devices include an installed application that implements the mobile device component of the instant selectable remote data system for the employee to operate as a provider. In an enterprise deployment, the provider is expected to be available to receive multimedia data requests. The mobile device application continuously sends the geographical location of the device to the central processing hub. The central processing hub keeps a running list of available multi-media data providers, along with their locations. In some implementations, the geographic location includes information related to internal building structure, such as what floor of a building a provider is current on, etc.

2. Submission of Multimedia Data Request by Consumer

An authorized individual within the enterprise (a “consumer”) who desires a photo or video of a specific geographic location/entity uses a website or custom application that implements the instant selectable remote data system by showing the location of all enterprise providers on a map display. The consumer can select a specific provider, or enter the location of the desired photo or video, and other parameters and instructions, such as viewing angle of the photo or video, etc.

3. Search and Matching of Data Provider Per User Criteria

The Request Matcher at the central processing hub searches the current list of available multimedia data providers and identifies a single provider that is currently available, meets the identified constraints in the consumer's criteria, and has the minimum effort required to provide the multimedia data, or selects by other prioritization schemes. The selected provider is notified by the central processing hub that the provider has a pending request. After the provider acknowledges and accepts the request, the consumer is notified that a provider is available, along with any additional information, such as estimated time to availability of the multimedia data.

4. Negotiation Between User and Matched Data Provider Per User Criteria

The system allows the consumer and selected provider to communicate with each other. Additional instructions may be provided by the consumer to the provider.

5. Delivery of Nominal Data by the Selected Data Provider to the Central Processing Hub

After the negotiations have been completed and all conditions accepted by both parties, the provider positions itself according to the agreed requirements and collects the requested multimedia data. The multimedia data is streamed or otherwise transmitted by network from the provider to the central processing hub.

6. Value-Added Services (e.g., Filtering) Applied to the Nominal Data

The central processing hub receives the multimedia data and the Multimedia Data Processor performs value-added services, such as filtering, to the multimedia data. For example, the Multimedia Data Processor may perform real-time analysis of video or images to detect the presence of aircraft or other vehicles/assets currently on the airport ramp. The Multimedia Data Processor may utilize additional information, such as ADS-B or airport surface surveillance to determine the position and identity of vehicles/assets and will place an augmented reality label or data tag on the video/image multimedia data to transform the nominal multimedia data into value-added multimedia data.

7. Delivery of Value-Added Data to the User

After the Multimedia Data Processor performs appropriate filtering on the nominal multimedia data to generate the value-added multimedia data, the multimedia data is then streamed or transmitted via a computer network to the consumer.

Use Case 3

A user wants to experience a personalized, guided tour of Pompeii.

1. Registration of Video Providers

This use case addresses an enhanced capability to address an industry-specific business case. In this use case, the providers of video/images are individuals with expertise in a location or attraction in their area that may be appropriate for a remote tour. The provider uses their own mobile device with an installed application that implements the mobile device component of the invention for the tour guide provider. In this use case, the tour guide provider may be available on demand, but the provider and consumer may also schedule a specific date and time for the tour. The tour guide provider can submit a profile of their background and knowledge of attractions and locations for which they offer remote tours. The central processing hub keeps a running list of tour guide multimedia data providers, along with their profiles.

2. Submission of Multimedia Data Request by Consumer

An individual (‘consumer’) who desires a remote guided tour of an attraction or specific geographic location/entity uses a website or custom application that implements the instant selectable remote data system by showing the location of all attractions/points of interest that have at least one tour guide provider registered to provide remote tours of that attraction. This website may use a map display, list, or other approach to show the providers. The consumer can select a specific tour guide provider, and other parameters and instructions, such as desired date/time, language of the tour, etc. Or the consumer can specify parameters to submit to the central processing hub for a recommendation of a tour guide provider.

3. Search and Matching of Data Provider Per User Criteria

The Request Matcher at the central processing hub searches the current list of available remote tour guide multimedia data providers and identifies a single provider that meets the identified constraints in the consumer's criteria. If the request is for an immediate remote tour, then the selected provider is notified by the central processing hub that the provider has a pending request. After the provider acknowledges and accepts the request, the consumer is notified that a provider is available, along with any additional information, such as estimated time to availability of the remote tour via streaming multimedia data. If the request is for a scheduled remote tour, then the Request Matcher makes a calendar entry on the remote tour guide provider's calendar within the provider's profile in the system.

4. Negotiation Between User and Matched Data Provider Per User Criteria

The system allows the consumer and selected provider to communicate with each other. Additional instructions may be provided by the consumer to the provider. Alternative dates and times may be coordinated by the provider and consumer through the negotiations. After the date and time is selected, it is entered onto the provider's profile schedule so that no other requests can be matched to that date and time for that provider.

5. Delivery of Nominal Data by the Selected Data Provider to the Central Processing Hub

After the negotiations have been completed and all conditions accepted by both parties, the provider positions itself according to the agreed requirements and conducts the tour via streaming multimedia data, which includes both real-time video of the attraction or location, and the provider's real-time spoken tour narrative as audio. The multimedia data is streamed or otherwise transmitted by network from the provider to the central processing hub. In this use case, the consumer can use an audio channel to ask questions of the remote tour guide.

6. Value-Added Services (e.g., Filtering) Applied to the Nominal Data

The central processing hub receives the multimedia data and the Multimedia Data Processor performs value-added services, such as filtering, to the multimedia data. For example, the Multi-Media Data Processor may perform real-time analysis of video or images to detect human faces or license plates. If detected, these items will be obscured in the image so that they cannot be used as personally identifiable information.
Value added video filtering will include augmented reality labelling of landmarks and other significant items based on publicly available map data
The tour guide provider can set up their own labels of items in the tour based on either geographical features, or image features. The system will remember the tour guides unique additions in their provider profile, and present them during their offered tours
The system will also recognize the provider's hand pointing and will put an augmented reality marker for both the provider and consumer to see so that the provider can point out specific items in the scene and the consumer can see what the provider is pointing at.

7. Delivery of Value-Added Data to the User

After the Multimedia Data Processor performs appropriate filtering on the nominal multimedia data to generate the value-added multimedia data, the multimedia data is then streamed or transmitted via a computer network to the consumer. The consumer can use an audio channel to ask questions of the remote tour guide.

Use Case 4

A user is having a plumbing problem and wants to have an expert look at the problem remotely. This use case addresses an enhanced capability to address an industry-specific business case.

1. Registration of Video Providers

The providers of video/images are individuals with expertise in professions or skills that may be desired by consumers. The provider uses their own mobile device with an installed application that implements the mobile device component of the instant selectable remote data system to provide consulting and guidance in their area of expertise. In this use case, the expert provider may be available on demand, but the provider and consumer may also schedule a specific date and time for the consulting support. The expert provider can submit a profile of their background and areas of expertise. The central processing hub keeps a running list of expert providers, along with their profiles.

2. Submission of Multimedia Data Request by Consumer

An individual (“consumer”) who desires to receive remote consulting in a specific profession or skill uses a website or custom application on their own computer, mobile device, or tablet that implements the invention by showing the list of registered expert providers. The consumer can select a specific expert provider, and other parameters and instructions, such as desired date/time, language, etc. Or the consumer can specify parameters to submit to the central processing hub for a recommendation of an expert provider.

3. Search and Matching of Data Provider Per User Criteria

The Request Matcher at the central processing hub searches the current list of available expert providers and identifies a single provider that meets the identified constraints in the consumer's criteria. If the request is for an immediate consulting session, then the selected expert provider is notified by the central processing hub that the provider has a pending request. After the provider acknowledges and accepts the request, the consumer is notified that a provider is available, along with any additional information, such as estimated time to availability of the consulting session via streaming multimedia data (expected to be within 10 minutes in this case).

If the request is for a scheduled consulting session, then the Request Matcher makes a calendar entry on the expert provider's calendar within the provider's profile in the system.

4. Negotiation Between User and Matched Data Provider Per User Criteria

The system allows the consumer and selected provider to communicate with each other. Additional instructions may be provided by the consumer to the provider. Alternative dates and times may be coordinated by the provider and consumer through the negotiations. After the date and time is selected, it is entered onto the provider's profile schedule so that no other requests can be matched to that date and time for that provider.

5. Delivery of Nominal Data by the Selected Data Provider to the Central Processing Hub

After the negotiations have been completed and all conditions accepted by both parties, the provider prepares itself according to the agreed requirements and conducts the consulting session via streaming multimedia data. In this use case, the streaming multimedia data includes two-way streaming of both audio and video data. The multimedia data is streamed or otherwise transmitted by network from the provider and the consumer to the central processing hub. Both the provider and the consumer use mobile computing devices to capture the multimedia data and to transmit it to the central processing hub. In this use case, the consumer can use an audio channel to ask questions and describe the issue that requires expert consulting, and the consumer can use the video channel to show images/video of the current condition/situation to be addressed. For example, if there is a leak under the sink, the consumer can use their device to show the pipe configuration and specific location of the leak to allow the remote expert to suggest what needs to be done to fix the problem.

6. Value-Added Services (e.g., Filtering) Applied to the Nominal Data

The central processing hub receives the multimedia data and the Multimedia Data Processor performs value-added services, such as filtering, to the multimedia data. In this case, both the provider's and consumer's multimedia data may be processed. For example, the Multimedia Data Processor may perform real-time analysis of video or images to detect human faces or license plates. If detected, these items will be obscured in the image so that they cannot be used as personally identifiable information.

7. Delivery of Value-Added Data to the User

After the Multimedia Data Processor performs appropriate filtering on the nominal multimedia data to generate the value-added multimedia data, the multimedia data is then streamed or transmitted via a computer network to the consumer or to the provider, as appropriate for this use case.

Use Case 5

A user needs a picture of people meeting around a business table, or a video of a person giving a business presentation.

1. Registration of Video Providers

Individual mobile device owners who have installed an application on their mobile device that implements the mobile device component of the instant selectable remote data system use the mobile device application to indicate whether or not they are available to receive general non-location-specific requests such as the one illustrated here. A “non-location-specific” request means a request through the application that can be satisfied anywhere in the world—geographic filtering is unnecessary. Other location-independent requests may include (but is not limited to) requests for photos of aircraft departing an airport (where the airport can be any one), pictures of a person on a paddleboard, and so forth. The consumer may use these pictures for marketing or other purposes, or perhaps as part of an art project, school assignment, or research.

2. Submission of Multimedia Data Request by Consumer

An individual who desires a photo or video that is not location-specific would use the application to describe the scene s/he desires. In this specific use case, the consumer would describe how many people should be at the table, whether they should be sitting or standing, whether one of them is giving a presentation, and the type of attire they should be wearing—business casual or business formal, for example.

3. Search and Matching of Data Provider Per User Criteria

The Request Matcher at the central processing hub searches the current list of available non-location-specific data providers and broadcasts the request to all such currently logged-in suppliers. Some subset of suppliers will reply with their availability, estimated time to complete the assignment, and desired price. Using a selection algorithm, the central processing hub will select one of them. The selection may be based on who is closest to the consumer (time zone considerations), who has bid the lowest price, or any other such selection criteria.

4. Negotiation Between User and Matched Data Provider Per User Criteria

The system allows the consumer and selected provider to communicate with each other, without sharing any personally identifiable information. The invention may block names, phone numbers, email addresses, or other personally identifiable information during this communication. Additional negotiation may occur, including additional fees and amount of time available to complete the transaction. In this specific example, the provider may have to gather individuals, get model releases, find a suitable business conference room (or rent one), and stage the shoot. Both parties must agree through the application to the additional fees and requirements.

5. Delivery of Nominal Data by the Selected Data Provider to the Central Processing Hub

After the negotiations have been completed and all conditions accepted by both parties, the provider positions itself according to the agreed requirements and collects the requested multimedia data. The multimedia data is streamed or otherwise transmitted by network from the provider to the central processing hub.

6. Value-Added Services (e.g., Filtering) Applied to the Nominal Data

The central processing hub receives the multimedia data and the Multimedia Data Processor performs value-added services, such as filtering, to the multimedia data. In this use case, the Multimedia Data Processor will confirm that all model release contracts have been received (if there are people posing specifically for the picture, such as business people in a business meeting), or that no such release is required (such as a photo of an airplane taking off). However, the Multimedia Data Processor may blur people, cars, license plates, or other objects that are in the background and for which permission has not been received.

7. Delivery of Value-Added Data to the User

After the Multimedia Data Processor performs appropriate filtering on the nominal multimedia data to generate the value-added multimedia data, the multimedia data is then streamed or transmitted via a computer network to the consumer.

### Use Case 6

A construction manager user wants to get a real-time aerial view of a project without traveling to the project site himself

1. Registration of Video Providers

Individual owners of drones install an application on their mobile device that implements the mobile device component of the instant selectable remote data system and links with the drone's controller application on the same mobile device. Drone owners use the mobile device application that implements the invention to indicate whether or not they are available to receive multimedia data requests. When they are available, the mobile device application continuously sends the geographical location of the device to the central processing hub. The central processing hub keeps a running list of available multi-media data providers, along with their locations, as well as pricing, capabilities, and constraints for each provider. In this case, one of the capabilities associated with this multimedia data provider is aerial images/video from a drone.

2. Submission of Multimedia Data Request by Consume

An individual who desires a photo or video of a specific geographic location/entity (“consumer”) uses a website that implements the instant selectable remote data system to enter the location of the desired photo or video, and other parameters and instructions, such as viewing angle of the photo or video, price that the consumer is willing to pay, time by which the photo or video is required, etc. To obtain aerial images/video from a drone, the consumer would specify that the request requires aerial images/video as part of the parameters of the request.

3. Search and Matching of Data Provider Per User Criteria

The Request Matcher at the central processing hub searches the current list of available multi-media data providers and identifies a single provider that is currently available, meets the identified constraints and requirements in the consumer's criteria, and has the minimum total cost required to provide the multimedia data. In this case, the Request Matcher only searches available providers that can provide multimedia data from a drone. The selected provider is notified by the central processing hub that the provider has a pending request. After the provider acknowledges and accepts the request, the consumer is notified that a provider is available, along with any additional information, such as estimated time to availability of the multimedia data.

4. Negotiation Between User and Matched Data Provider Per User Criteria

The system allows the consumer and selected provider to communicate with each other, without sharing any personally identifiable information. The instant selectable remote data system may block names, phone numbers, email addresses, or other personally identifiable information during this communication. Additional negotiation may occur, including additional fees and amount of time available to complete the transaction. For example, the provider may need to travel to the location of the consumer's request, which may include tolls to be paid, or other travel-related charges, as well as time. Both parties must agree through the application to the additional fees and requirements.

5. Delivery of Nominal Data by the Selected Data Provider to the Central Processing Hub.

After the negotiations have been completed and all conditions accepted by both parties, the provider positions itself according to the agreed requirements, initiates the drone flight in the appropriate location, and collects the requested multimedia data. The multimedia data is streamed or otherwise transmitted by network from the provider to the central processing hub.

6. Value-Added Services (e.g., Filtering) Applied to the Nominal Data

The central processing hub receives the multimedia data and the Multimedia Data Processor performs value-added services, such as filtering, to the multimedia data. For example, the Multimedia Data Processor may perform real-time analysis of video or images to detect human faces or license plates. If detected, these items will be obscured in the image so that they cannot be used as personally identifiable information.

Another example of a value-added service is for the central processing hub to allow individuals (not consumers or providers, in general) to verify ownership of their property and then indicate to the system implementing the invention that their property is not to be included in any multimedia data provided by the system. If this value-added service is enabled in the system, then multimedia data is analyzed by the Multimedia Data Processor to identify and obscure or block any segments of the image or video that are identified by the system to be from any blocked properties.

7. Delivery of Value-Added Data to the User

After the Multimedia Data Processor performs appropriate filtering on the nominal multimedia data to generate the value-added multimedia data, the multimedia data is then streamed or transmitted via a computer network to the consumer.

Many other use cases of the instant selectable remote data system are possible and captured by the disclosure. For example, a hairdresser may perform a consultation over remote video, a real-estate tour may be performed over remote video, someone in line at a popular nightclub may serve as a data provider to inform a user of the length of the line, a data provider could provide images or video of a proposed vacation spot or a specific city. An operator if an airport/FBO service may want to be able to see the airfield immediately, perhaps because of a reported issue like debris, incident, unauthorized access, etc., a user may wish to seek a data provider to photograph the length of the line at an amusement park ride to decide which ride has the shorter line.

An express carrier, e.g., FedEx or UPS, may want to remotely monitor cargo processing and movement or other logistics throughout their sorting complex, a warehouse or factory operator may want to get a real-time view from their control center of current activities on the warehouse or factory floor, or a remote medical specialist may provide support for EMTs in the field. A user may wish to determine the status of a vacation home/boat/business after a serious storm or during or after a serious fire. Most generally, any business that deploys field technicians may use the instant selectable remote data system to provide expert remote support from another location such as a headquarters facility.

The exemplary systems and methods of this disclosure have been described in relation to systems and methods involving instant selectable remote data access and/or viewing. However, to avoid unnecessarily obscuring the present disclosure, the preceding description omits a number of known structures and devices, and other application and embodiments. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the methods have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A remote data delivery system comprising:
a set of remote data provider electronic devices each operated by a remote data provider, each of the set of remote data provider electronic devices configured to: a) transmit a remote data provider registration data set comprising a remote data provider profile and a remote data provider state, the remote data provider state comprising a remote data provider location, a remote data provider data collection format, and a remote data provider temporal availability, and b) collect and transmit a remote data provider nominal data set;
a user electronic device operated by a user, the user electronic device configured to transmit a user data collection request comprising user data collection requirements, the user data collection requirements comprising user requested data collection location, user data collection time, and user requested data collection format; and
a central processing hub configured to: a) receive the remote data provider registration data sets from each of the remote data provider electronic devices, b) enable the user to view the remote data provider registration data sets using the user electronic device, c) receive the user data collection request, d) enable each of the remote data providers to view the user data collection request using the respective remote data provider electronic device, e) sort the remote data provider data sets with respect to the user data collection request, and f) exchange data collection proposed terms between the user and each of the remote data providers;
wherein:
the central processing hub sorts the remote data provider data sets with respect to the user data collection request to identify a set of bona fide remote data providers, the set of bona fide remote data providers satisfying the user data collection requirements;
the user selects a particular remote data collection provider from the set of bona fide remote data providers;
the central processing hub exchanges data proposed terms between the user and the particular remote data provider; and
if the data collection proposed terms yield data collection final terms, the remote data provider electronic device of the particular remote data provider collects a particular remote data provider nominal data set and transmits the particular remote data provider nominal data set to the user electronic device by way of the central processing hub.

2. The system of claim 1, wherein the set of bona fide remote data providers and a particular recommended bona fide remote data provider are presented to the user on the user electronic device, the particular recommended bona fide remote data provider identified by the central processing hub.

3. The system of claim 2, wherein the geo-location of the set of bona fide remote data providers are presented in a map display to the user on the user electronic device.

4. The system of claim 1, wherein the user requested data collection format is at least one of video data, still photograph data, and audio data.

5. The system of claim 1, wherein the user communicates with the particular remote data provider in real-time regarding the user data collection requirements.

6. The system of claim 1, wherein the data collection proposed terms comprise pricing terms and payment terms.

7. The system of claim 1, wherein the central processing hub filters the particular remote data provider nominal data set to remove identifying data of the particular remote data provider.

8. A remote data delivery system comprising:
a first remote data provider electronic device operated by a first remote data provider, the first remote data provider electronic device operating to: a) transmit a first remote data provider registration data set comprising a first remote data provider profile and a first remote data provider state, the first remote data provider state comprising a first remote data provider location, first remote data provider temporal availability, and first remote data provider data collection format, and b) collect and transmit a first remote data provider nominal data set;
a user electronic device operated by a user, the user electronic device operating to transmit a user data collection request comprising user data collection requirements, the user data collection requirements comprising user requested data collection location, user requested data collection time, and user requested data collection format; and
a central processing hub operating to: a) receive the first remote data provider registration data set, b) enable the user to view the first remote data provider registration data set using the user electronic device, c) receive the user data collection request, d) enable the first remote data provider to view the user data collection request using the first remote data provider electronic device, and e) exchange data collection proposed terms between the user and the first remote data provider;
wherein:
if: a) the first remote data provider location matches the user requested data collection location, b) the first remote data provider collection temporal availability matches the user required data collection time, and c) the first remote data provider data collection format matches the user requested data collection format, the central processing hub exchanges data collection proposed terms between the user and the first remote data provider; and
if the data collection proposed terms yield data collection final terms, the first remote data provider electronic device collects the first remote data provider nominal data set and transmits the first remote data provider nominal data set to the user electronic device by way of the central processing hub.

9. The system of claim 8, wherein the data collection proposed terms comprise user proposed financial terms and first remote data provider proposed financial terms.

10. The system of claim 8, wherein the first remote data provider electronic device is a portable electronic device and the user electronic device is a portable electronic device.

11. The system of claim 8, wherein any identification data of the first remote data provider nominal data set is removed to create the first remote data provider value-added data set.

12. The system of claim 8, wherein the central processing hub is a cloud-computing system.

13. The system of claim 8, wherein the user requested data collection format is at least one of video data, still photograph data, and audio data.

14. The system of claim 8, wherein the user communicates with the first remote data provider in real-time regarding the user data collection requirements.

15. A method of delivering selectable remote data to a user, the method comprising:
registering a set of remote data providers on a central processing hub, each remote data provider operating a remote data provider electronic device, each remote data provider electronic device configured to: a) transmit a remote data provider registration data set comprising a remote data provider profile and a remote data provider state, the remote data provider state comprising a remote data provider location, a remote data provider data collection format, and a remote data provider temporal availability, and b) collect and transmit a remote data provider nominal data set;
transmitting a user data collection request from a user electronic device to the central processing hub, the user data collection request comprising user data collection requirements comprising user requested data collection location, user required data collection time, and user requested data collection format, the user electronic device operated by a user;
selectively viewing, by the user on the user electronic device, one or more remote data provider registration data sets of the set of remote data providers;
sorting, by the central processing hub, the set of remote data providers to identify a set of bona fide remote data providers which satisfy the user data collection requirements;
selecting a particular remote data provider among the set of bona fide remote data providers;
exchanging data collection proposed terms between the user and the particular remote data provider;
establishing data collection final terms;
collecting, by the remote data provider electronic device of the particular remote data provider, a particular remote data provider nominal data set;
transmitting the particular remote data provider nominal data set the central processing hub;
filtering the particular remote data provider nominal data set according to selectable criteria to create a filtered data set; and
transmitting the filtered data set to the user electronic device.

16. The method of claim 15, wherein the set of bona fide remote data providers is presented to the user on the user electronic device.

17. The method of claim 15, wherein the particular remote data provider nominal data set includes at least one of video data, still photograph data, and audio data.

18. The method of claim 15, wherein the selectable criteria removes identification data associated with at least one of: the particular remote data provider, people other than the particular remote data provider, and entities requiring deidentification.

19. The method of claim 15, wherein the user communicates with the particular remote data provider in real-time regarding the user data collection requirements.

20. The method of claim 15, wherein the data collection proposed terms comprise pricing terms and payment terms.
